(19) United States
(12) Patent Application Publication
(10) Pub. No.: US 2011/0097542 A1
(43) Pub. Date: Apr. 28, 2011

(54) Compensation element

(75) Inventor: Armin Pfeil, Kaufering (DE)

(73) Assignee: Hilti Aktiengesellschaft

(21) Appl. No.: 12/925,335

(22) Filed: Oct. 18, 2010

(30) Foreign Application Priority Data
Oct. 22, 2009 (DE) 10 2009 045 910.3

(51) Int. Cl. B32B 3/10; C08L 63/00; C08L 9/00; C08L 67/00; C08L 75/04

(52) U.S. Cl. 428/138; 525/523; 525/55; 525/387; 525/453

(57) ABSTRACT

A compensation element for leveling an add-on part (12) relative to a constructional component (13) has a base body (22) in which a curable material is embedded in a dispersed manner and is activated under pressure for changing a deformable condition of the base body (22; 32) to a rigid condition.

### BACKGROUND OF THE INVENTION

1. Field of the Invention

The present invention relates to a compensation element for leveling an add-on part relative to a constructional component and having a base body provided with a curable material.

2. Description of the Prior Art

Add-on parts such as, e.g., frames, handrails, or façade elements should meet, with respect to constructional components such as floors, walls, or ceilings which, e.g., are formed of materials such as concrete or masonry, different requirements with regard to precision of their manufacturing. The add-on parts are secured to a constructional component with fastening means which includes fastening elements.

German patent publication DE 102 08 362 A1 discloses a mechanically adjustable element that serves as a compensation element and is provided with a threaded bolt that engages in the thread in a support element and is axially displaceable relative thereto for leveling the support element.

The drawback of this known solution consists in that the adjustable element requires a large space for its arrangement and its operation is expensive because of its complex constructions.

Further, massive, e.g., U-shaped disc element, which have different thicknesses and are positioned around a fastening element, are used as compensation elements. For shimming the add-on part, a number of disc elements corresponding to a predetermined height compensation, are placed one upon another. For leveling the add-on part, firstly, the add-on part is provisionally secured to the constructional component and is aligned relative thereto. After the fastening elements are released, additional disc elements are provided for separate fastening elements or excessive disc elements are removed. Then, the fastening elements are tightened again and a control measurement is carried out. As long as the alignment remains non-exact, the above-mentioned steps need to be repeated until a predetermined alignment is achieved.

The drawback of the this known solution consists in that for leveling of the add-on part, a number of operational steps are needed and, therefore, the mounting of add-on parts is time-consuming and cost-intensive.

German Patent Publication DE 10 2007 058 861 A1 discloses a compensation element for leveling an add-on part relative to a constructional component and having an elastic base body and a curable material provided in separate chambers of the base body.

The drawback of this known solution consists in that the base body should be provided with separate chambers for receiving the curable material and, as a result, the base body has inhomogeneous compressibility, which prevents an exact alignment of the add-on part. Further, the known compensation element has only a small cross-linking density, so that it has, in a cured condition, only a small mechanical carrying capacity, e.g., pressure resistance and further has, in some cases, a certain elasticity which is undesirable in the operating condition of the add-on part.

Accordingly, an object of the present invention is to provide a compensation element for leveling an add-on part relative to a constructional component that can be easily used and, thereby, enables an exact alignment of the add-on part.

### SUMMARY OF THE INVENTION

This and other objects of the present invention, which would become apparent hereinafter, are achieved by providing a compensation element in which the curable material is embedded in the base body in a dispersed manner, and the curable material is activated under pressure for changing a deformable condition of the base body to a rigid condition.

The base body can be advantageously adapted to both the structure of a corresponding outer surface of the add-on part and the structure of a corresponding outer surface of the constructional component, and has essentially a uniform compressibility over its entire volume. Because of the curable mass being advantageously distributed over the entire volume of the base body in minute quantities, a complete curing of the base body after activation of the curable material is insured. Upon mounting of the add-on part, the base body of the compensation element is compressed to a certain degree which leads to start of the curing process of the curable mass.

The curable compensation element, before being cured, behaves as a rubber-like resilient material, i.e., is compressible and, thus, the position of the add-on part is easily adjustable. During curing of the curable material, the material behavior of the compensation element is transformed in behavior of a stiff rigid body in a controlled manner, so that it can withstand completely the loads generated during operation.

The curing of the compensation element is advantageously so adjusted that after initialization, a sufficient time becomes available for alignment of the add-on part by application of pressure to the compensation element and, simultaneously, the curing process is sufficiently advanced by the time the alignment is completed. In order to have a sufficient correction possibility for long add-on parts, e.g., façade elements, the curing time of the curable material should be in the range from about five to seven hours. Dependent on the application, the curing time of the curable material can be adjusted from a couple of minutes to a couple of hours. The simpler the leveling of the add-on part, the shorter the curing time of the curable material can be adjusted.

Advantageously, the base body is formed as a cuboid or a disc so that a sufficiently large bearing surface is available for bearing against the constructional component and/or against the add-on part. Further, other arbitrary changes, which match, e.g., edge conditions at the application site, can be made when shaping the base body.

Advantageously, the base body has a spring stiffness corresponding to compressibility up to 80%, whereby the expansion of the compensation element for leveling the add-on part upon release of a tightened fastening element is insured.

Further advantageously, the base body has a porous, particularly advantageously, a microporous structure, so that upon application of pressure, the released curable material can easily diffuse in the matrix of the base body and react therewith. Thereby, a homogeneous stabilization of the base body in the cured condition of the compensation element is insured. E.g., the base body can have a sponge-like structure.

Advantageously, the curable material is provided with microelements which are destroyed under pressure and which are easily breakable and release the curable material, so that the curing process of the curable material can start. The curable material advantageously is provided in form of microcapsules and/or hollow microfibers which are particularly suitable for this application. Advantageously, the microelements, which are destroyed under pressure, have, in view of their mechanical characteristics, their wall formed so that they are brittle, and they adhere well to the material of the base body. As a result the walls break easily and rapidly upon deformation of the base body.

Advantageously, the curable material includes several components which are embedded in the material separately from each other in a dispersed manner. Advantageously, these components include a resin and a curing agent which react upon contact with each other and advantageously cure the entire base body. The resin includes, e.g., epoxide resin, dicyclopentadiene, accelerated radical curable resin such as e.g., non-saturated polyester, vinylester, vinylester urethane, advantageously, respectively, diluted with styrene and/or methacrylates and the like, and isocyanate. The curing agent includes, e.g., amine curing agent, benzoyl peroxide, or other suitable peroxide initiators, polyol, or polyamine.

If the base body has a porous or microporous structure, at least one of the components of the curable material can be provided in base body pores. A porous base body establishes, after initialization of the curing process, a rapid contact between the components of the curable material and, thus, guarantees an immediate reaction between the components.

Advantageously, the curable material includes a catalyst that controls the curing time and, thus, the available time for alignment of the add-on part. To this end, suitable catalysts for, e.g., epoxide resin, are tertiary amines, phenols, methanethiols, boron-trifluoride complexes, beta-amino-ketones, Grubb's catalysts (ruthenium-carbon complexes of the first or second generation), or also hoveyda catalysts; for an amine accelerator of a radical curable resin, for polyurethane on basis of amine (and its derivatives), and tin-organic compounds, bismuth octoate and the like. The catalysts are provided either in the resin or in the curing agent. With dicyclopentadiene as resin, the catalyst can be provided as a separate component of the curable material. Alternatively, catalysts can form, e.g., in addition to the resin and the curing agent, further components of the curable mass.

Advantageously, as a material of the base body, a polymer that has advantageous elastic characteristics and can react with a number of curable materials, is used, so that, upon activation of the curable material, and advantageously, the entire base body is cured.

As discussed above, advantageously, an elastomer, which has particularly advantageous elastic characteristics, is used as a material of the base body. Suitable elastomers are, e.g., normal elastomers such as, e.g., acrylate rubber, ethylene-acrylate rubber, polyurethane rubber, bromine butyl rubber, chlorine butyl rubber, epichlorohydrin polymer, chloroprene rubber, chlorine-sulforized polyethylene, ethylene oxide-epichlorohydrin rubber, ethylene-propylene-diene rubber, perfluorine rubber, fluorine rubber, fluorine methyl-silicone rubber, butyl rubber, acrylonitrile-butadiene rubber, natural rubber, or styrene-butadiene rubber. Alternatively, thermoplastic elastomers can be used, such e.g., (TPE-O or TPO=thermoplastic elastomers on an olefin basis), mainly, PP/EPDM e.g. Santroprene™ (Firm AES/Monsato; TPE-V or TPV (cross-linked thermoplastic elastomers on an olefin basis, mainly PP/EPDM, e.g., Sarlink® (firm DSM), Forprene® (firm SoFter), TPE-U or TPU (thermoplastic elastomers on a urethane basis, e.g., Desmopan®, Texin®, Utechllan® (firm Bayer), TPE-E or TPC (thermoplastic copolyesters, e.g., Hytrel® (firm DuPont), TPE-S or TPS (styrene block copolymers (SBS, SEBS, SEPS, SEEPS, and MBS), e.g., Septon™ (firm Kuraray) or Thermoplast-K (firm Kraiburg), or TPE-A or TPA (thermoplastic copolyamides, e.g., PEBAX® (firm Arkema).

Advantageously, the elastomer includes groups capable of cross-linking and to react with the curable material, which insures a complete curing of the base body after activation of the curable material. To this end, suitable groups are, e.g., in case of epoxide resins, epoxide or primary/secondary amine groups; in case of Grubb's catalysts, norbonyl groups; in case of peroxide cross-linking, unsaturated groups (double bonds) or easily extractable hydrogen atomes; in case of isocyanates, hydroxyle and/or amino groups.

Advantageously, at least one through-opening for a fastening element is provided in the base body, so that in the mounted condition, the compensation element surrounds the fastening element extending through the through-opening. With this arrangement of the compensation element with respect to the fastening element, an exact alignment of the add-on port in and advantageous manner becomes possible.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 an arrangement of a add-on part with two compensation elements in a mounted condition;

FIG. 2 a perspective view of one of compensation elements shown in FIG. 1;

FIG. 3 a cross-sectional cut-out view of a compensation element at an increased, in comparison with FIG. 2, scale; and

FIG. 4 a cross-sectional cut-out view of another embodiment of a compensation element.

In the drawings, basically, the same elements are designated with the same reference numerals.

### DETAILED DESCRIPTION OF THE PREFERRED EMBODIMENTS

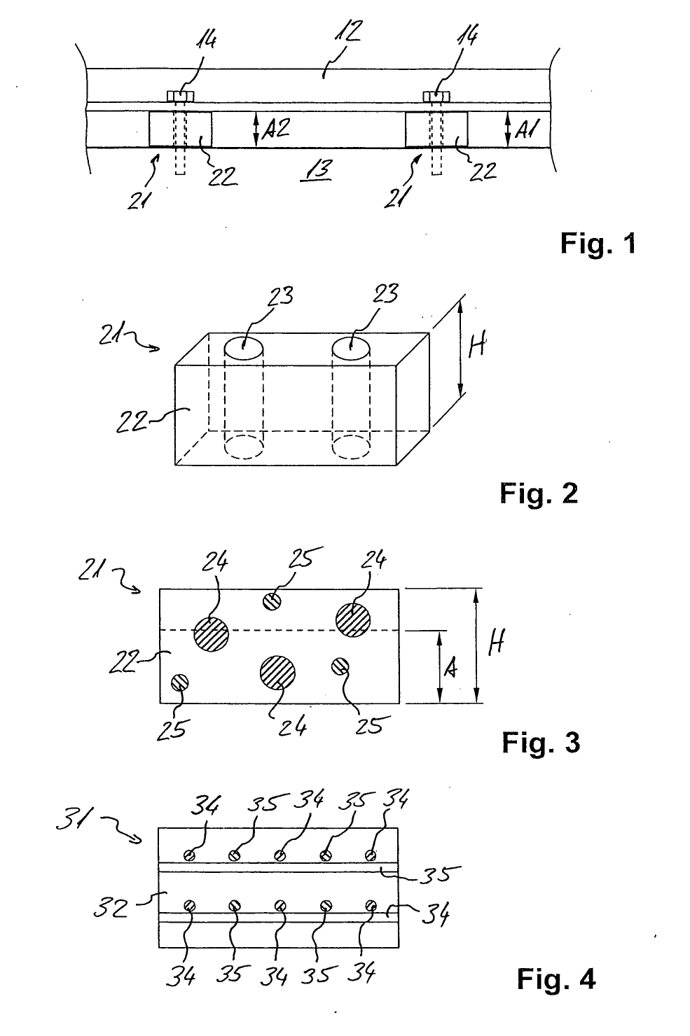

A compensation element 21 according to the present invention for leveling an add-on part 12 relative to the constructional component 13 and which is shown in the mounted condition in FIG. 1 and separately in FIGS. 2-3, has an elastic base body 22 and a curable material provided in the base body.

The material, of which the base body 22 is formed, is a polymer, particularly advantageously, cross-linkable groups reacting with the curable material. The base body material has a microporous structure. Suitable material are normal elastomers and thermoplastic elastomers. In a non-mounted condition, the base body 22 and, thus, the compensation element 21 has a height H. The base body 22 advantageously has a constant stiffness, up to a certain degree, under pressure.

The multi-component material includes resin 24 and a curing agent 25 which are embedded in the material of the base body 22 separately from each other in a dispersed manner. The resin 24 and the curing agent 25 are provided in form of microbulbs as microelements which are distructed under pressure. The curable material further contains a catalyst. For transferring the base body 22 from a deformable condition to a rigid condition upon compression of the base body 22, e.g., to a reduced height A, the curable material is activated.

Below, four, not exclusive, examples of suitable multi-component curable mass are given:

| | Resin | Curing Agent | Catalyst |
|---|---|---|---|
| Expl. 1 | Epoxide resin | Amine or | Tertiary amine, phenol, |
| | | methanetiol | methanetiol, boron-tri- |
| | | | fluoride complex or beta- |
| | | | amino-keton (dissolved in |
| | | | the curing agent) |
| Expl. 2 | Dicyclopentadiene | | Grubb's catalyst (as a |
| | | | separate second component) |
| Expl. 3 | Accelerated radical curable | Benzoylperoxide | Amine accelerator |
| | resin (e.g., non-saturated | or other suitable | (dissolved in the resin) |
| | polyester, vynilester, | peroxide initiators | |
| | vynilester urethane etc., | | |
| | diluted with sterene and/or | | |
| | methacrylates and the like) | | |
| Expl. 4 | Isocyanate | Polyol or | Catalysts on basis of amines |
| | | polyamine | (and their derivative) and |
| | | | tin-organic compounds, bismuth |
| | | | octoate, etc. (dissolved in polyol) |

For leveling the add-on part 12 relative to the constructional component 13 (see arrangement 11 in FIG. 1), firstly, a number of compensation elements 21 corresponding to a number of fastening elements 14 is provided on the constructional component, and then the add-on part 12 is placed on the compensation elements 21. In their non-cured condition, the compensation elements 21 have a specific stiffness sufficient for receiving the net weight of the add-on part 12. With fastening elements 14 anchored in the constructional component 13, the height H of the compensation elements 21 is reduced to the necessary height A1 or A1 for leveling the add-on part 12. The microelements are destroyed, and the resin 24 and the curing agent 25 are released in the material of the base body 22, and the reaction between the resin 22 and the curing agent begins. Dependent on the profile of the constructional component 13, e.g., precision of the outer surface of the constructional component 13, the compensation elements 21 would have, in the mounted condition, different degrees of compression and, thus, different reduced heights A1 or A2.

At least at the beginning of the curing period, the compensation element 21 remains compressible and flexible for a predetermined time period. After the curable material is cured, the compensation element 21 has a high stiffness and can withstand the entire load.

The compensation element 31, which is shown in FIG. 4, likewise has an elastic body 32 and distinguishes from the compensation element 21 only in that the components 34 and 35, the resin and the curing agent of the curable material activated under pressure, are provided in form of hollow microfibers as microelement destructible under pressure.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A compensation element for leveling an add-on part (12) relative to a constructional component (13) comprising an elastic base body (22, 32), and a curable material embedded in the base body (22; 32) in a dispersed manner, the curable material being activated under pressure for changing a deformable condition of the base body (22; 32) to a rigid condition.

2. A compensation element according to claim 1, wherein the curable material is provided in form of destructible, under pressure, microelements.

3. A compensation element according to claim 1, wherein the curable material comprises several components (24, 25; 34, 35) embedded in a base body material in a dispersed manner.

4. A compensation element according to claim 3, wherein the curable material comprises a catalyst.

5. A compensation element according to claim 1, wherein a material, of which the base body (22; 32) is formed, is polymer.

6. A compensation element according to claim 5, wherein the base body material is elastomer.

7. A compensation element according to claim 6, wherein the elastomer contains cross-linkable groups reacting with the curable material.

8. A compensation element according to claim 1, wherein the base body (22) is provided with at least one through-opening (23) for a fastening element (14).
